(19) United States
(12) Patent Application Publication
(10) Pub. No.: US 2010/0246666 A1
(43) Pub. Date: Sep. 30, 2010

(54) BLUFLEX: FLEXIBLE, TRUE, LIVE VIDEO STREAMING ON BLU-RAY PLATFORMS

(75) Inventors: Valentino Miazzo, Macherio (IT); Gregory Maertens, Cernusco Sul Naviglio (IT); Davide Maestroni, Lainate (IT); Stefano Padovan, Milano (IT); Bob Saffari, San Carlos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mozaik Multimedia, Inc., Redwood City, CA (US)

(21) Appl. No.: 12/644,514

(22) Filed: Dec. 22, 2009

Related U.S. Application Data
(60) Provisional application No. 61/141,615, filed on Dec. 30, 2008.

(51) Int. Cl. H04N 11/02; G06F 15/16; H04N 5/91

(52) U.S. Cl. 375/240.01; 709/231; 386/46; 386/E05.003; 375/E07.026

(57) ABSTRACT

In various embodiments, systems, methods, and computer-readable storage media are disclosed for generating content streams that conform to the Blu-ray Specification. In some embodiments, to provide true live streaming of content that conforms to the Blu-ray Specification to platforms that conforms to the Blu-ray Specification, one or more content stream creation devices (e.g., A/V encoders and multiplexers) are passed information on how the output file for a transport stream should be formatted. A plurality of Clip Information files may be used to create the transport stream for the content. Platforms that conform to the Blu-ray Specification may be configured to select which one of the plurality of Clip Information files were used to create all or a portion of the transport stream and use that Clip Information file during playback.

### CROSS-REFERENCES TO RELATED APPLICATIONS

This Application claims priority to and the benefit of U.S. Provisional Application No. 61/141,615, filed Dec. 30, 2008 and entitled “BLUFLEX: FLEXIBLE, TRUE, LIVE VIDEO STREAMING ON BLU-RAY PLATFORMS,” which is hereby incorporated by reference for all purposes.

### BACKGROUND OF THE INVENTION

Blu-ray Disc (also known as Blu-ray or BD) is an optical disc storage medium. Generally, BD has the same physical dimensions as standard Digital Versatile Discs (also know as Digital Video Discs or DVDs) and Compact Discs (CDs). The main uses of BD can include the storage of data, high-definition video, and games. BD may support storage capacities of around 25 GB per single layered and 50 GB per dual layered disc. Thus, a two-layer Blu-ray Disc can store approximately six times the capacity of a two-layer DVD, or ten times that of a single-layer DVD. The name Blu-ray Disc may be derived from the blue laser (violet-colored) used to read and write this type of disc. Because of the beam's shorter wavelength (about 405 nanometers), substantially more data can be stored on a Blu-ray Disc than on discs configured to be read by lasers having a longer wavelength, such as a red laser (about 650 nm) typically used for DVDs. Other optical storage mediums, such as HD-DVD, may incorporate such blue laser technology to achieve greater storage capacities than standard DVDs and CDs

Blu-ray Discs are just one example of media used by platforms that conform to the Blu-ray Specification for obtaining content that conforms to the Blu-ray Specification. Such platforms may include consumer electronic devices and personal computer systems that read BDs. The Blu-ray Specification can not only offer high definition video and high quality audio one these platforms, but also new interactive environments. The Blu-ray Specification provides for interactivity layers (e.g., BD-Java or BD-J) that create new opportunities for interactive movie experiences, network connectivity, gaming, social interactivity, or the like. With the addition of such advanced interactivity via network connectivity, platforms that conform to the Blu-ray Specification can not only offer high definition video and high quality audio recorded on BDs, but also high definition video and high quality audio provided via downloading and streaming.

Accordingly, what is desired are improved methods and apparatus for solving some of the problems related to downloading and streaming content for platforms that conform to the Blu-ray Specification, some of which may be discussed herein. Additionally, what is desired are improved methods and apparatus for reducing some of the drawbacks related to downloading and streaming content for platforms that conform to the Blu-ray Specification, some of which discussed may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be present some innovations, embodiments, and/or examples found within this disclosure in a simplified form as a prelude to a more detailed description presented later.

In various embodiments, systems, methods, and computer-readable storage media are disclosed for generating content streams that conform to the Blu-ray Specification. In some embodiments, to provide true live streaming of content that conforms to the Blu-ray Specification to platforms that conforms to the Blu-ray Specification, one or more content stream creation devices (e.g., A/V encoders and multiplexers) are passed information on how the output file for a transport stream should be formatted. A plurality of Clip Information files may be used to create the transport stream for the content. Platforms that conform to the Blu-ray Specification may be configured to select which one of the plurality of Clip Information files were used to create all or a portion of the transport stream and use that Clip Information file during playback.

In some embodiment, platforms that conform to the Blu-ray Specification may be configured to loop over the plurality of Clip Information files from a given playlist to stream real time data. In further embodiments, BD angles may be used a means to optimize video compression. Each one of the plurality of Clip Information files may represent a BD angle at a different encoding. A transport stream or portion of a transport stream may be generated based on the plurality of Clip Information files at different encodings. Additionally, the BD angles may be used to optimize network bandwidth and provide seamless presentation to the user as angles are switched.

In some embodiments, streaming is provided with a small amount of persistent storage. In other embodiment, larger storage may be used for timeshifting of live streaming data.

In other embodiments, to provide true live streaming of content that conforms to the Blu-ray Specification to platforms that conforms to the Blu-ray Specification, the one or more content stream creation devices (e.g., A/V encoders and multiplexers) generate A/V chunks of fixed duration. One or more metrics associated with the content may be used to determine a common denominator for sizing the fixed duration.

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 is a block diagram illustrating the generation of content that conforms to the Blu-ray Specification.

FIG. 2 is a block diagram of a system for playback of content that conforms the Blu-ray Specification in one embodiment according to the present invention.

FIG. 3 is a block diagram of a system for generating streams of Blu-ray Specification conforming content in one embodiment according to the present invention.

FIG. 4 is a flowchart of a method for generating streams of Blu-ray Specification conforming content in one embodiment according to the present invention.

FIG. 5 illustrates a message sequence chart for streaming of content conforming to the Blu-ray Specification in one embodiment according to the present invention.

FIG. 6 is a flowchart of another method for generating streams of Blu-ray Specification conforming content in one embodiment according to the present invention.

FIG. 7 illustrates a message sequence chart for streaming of content conforming to the Blu-ray Specification in one embodiment according to the present invention.

FIG. 8 is a block diagram of a computer system, information processing device, or consumer electronic device that may incorporate an embodiment, be incorporated into an embodiment, or be used to practice any of the innovations, embodiments, and/or examples found within this disclosure.

### DETAILED DESCRIPTION OF THE INVENTION

In general, downloading and streaming content for platforms that conform to the Blu-ray Specification have some restrictions. For example, three levels (represented by three files) are specified for platforms conforming to the Blu-ray Specification that may be required for playback of streaming content that conforms Blu-ray Specification. At the highest level is a “Movie PlayList.” A playlist is a collection of playing intervals in one or more clips. One such playing interval is called a PlayItem and consists of an IN-point and an OUT-point, each of which refers to positions on a time axis of a clip. An IN-point means a start point of a playing interval, and an OUT-point means an end point of the playing interval. A playlist therefore is a collection of PlayItems.

An AV stream file together with its associated database attributes is considered to be one object. The AV stream file is called a “Clip AV stream file,” and the associated database attribute file is called a “Clip Information filermation” file. An object consisting of a Clip AV stream file and its corresponding Clip Information file is called a Clip.

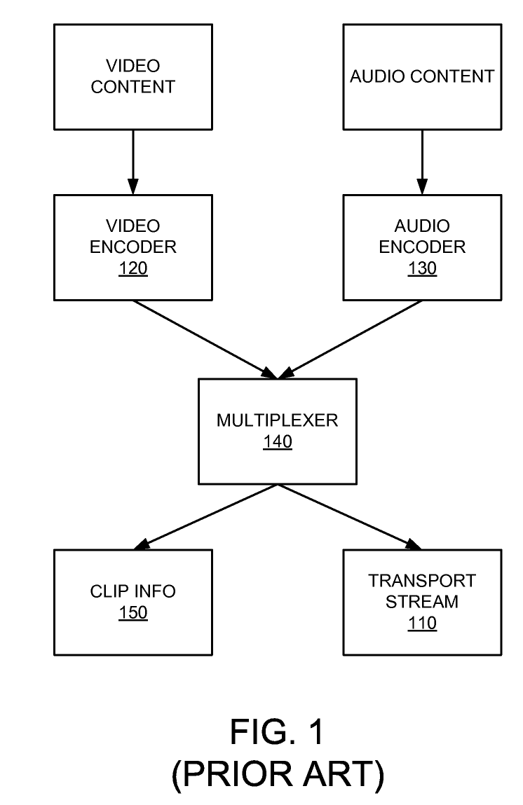

At the lowest level, a Clip AV stream file stores an MPEG-2 Transport Stream (ISO/IEC 13818-1) contained in a structure compliant with the BD-ROM AV specification. This structure is called the “BDAV MPEG-2 Transport Stream.” The MPEG-2 Transport stream (TS, TP, MPEG-TS, M2T, or M2TS) is a communications protocol for packetized elementary streams of audio, video, and data. M2TS provides digital container format that encapsulates these streams and data. As shown in FIG. 1, transport stream 110 can include video content and audio content that has been encoded (e.g., compressed) by video encoder 120 and audio encoder 130. Multiplexer 140 multiplexes the output from video encoder 120 and audio encoder 130 to create transport stream 110.

M2TS is specified in MPEG-2 Part1, Systems (ISO/IEC standard 13818-1), which is hereby incorporated by reference for all purposes. It is also known as ITU-T Rec. H.222.0, which is hereby incorporated by reference for all purposes. M2TS may offer features for error correction for transportation over unreliable media, and can be used in recorded media applications, such as Blu-ray Discs, and broadcast applications, such as Digital Video Broadcasting (DVB) and Advanced Television Systems Committee (ATSC) broadcasts. It is contrasted with MPEG program stream (PS), designed for media such as DVDs.

Generally, transport stream 110 was designed for tape and broadcast and by itself usually contains all information necessary for playback. Transport stream 110 may require some modifications for usage with random-access media devices, such as digital camcorders that record onto optical disks, Blu-ray Discs, hard drives, or solid-state memory cards. A stream directory (e.g., STREAM) may be created that includes a plurality of audio and video stream files recorded in a Blu-ray Disc according to the Blu-ray format.

Another layer (or set of files in addition to the STREAM directory) may be required to implement random access. Accordingly, above any transport stream files may exist one or more Clip Information (Clip Information file) files (e.g., Clip Information file 150). A Clip Information file generally stores time stamps of the access point into a corresponding AV stream file. Platforms conforming to the Blu-ray Specification read the Clip Information file to find out the position where they should begin to read the data from the corresponding AV stream file. There is a one-to-one relationship between a Clip AV stream file and a Clip Information file. Thus, a Clip Information file can include metadata associated with multiplexed audio/video data that describe a transport stream, such as time-to-data offset information, key frame position, multiangle, multiaudio information, or the like. A Clip Information directory (e.g., CLIPINF) may be created that is composed of a plurality of Clip Information file files connected to the A/V stream files.

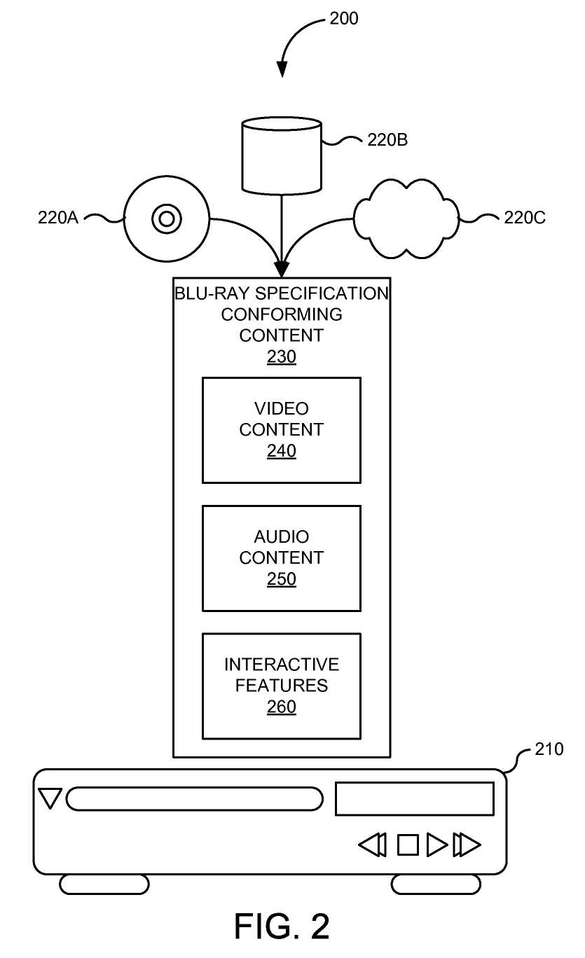

FIG. 2 is a block diagram of system 200 for playback of content that conforms the Blu-ray Specification in one embodiment according to the present invention. FIG. 2 is a simplified illustration of system 200 that may incorporate various embodiments or implementations of the one or more inventions presented within this disclosure. FIG. 2 may merely be illustrative of an embodiment or implementation of an invention disclosed herein should not limit the scope of any invention as recited in the claims. One of ordinary skill in the art may recognize through this disclosure and the teachings presented herein other variations, modifications, and/or alternatives to those embodiments or implementations illustrated in the figures.

In this example, system 200 includes Blu-ray platform 210. Blu-ray platform 210 is representative of platforms that conform to the Blu-ray Specification. Blu-ray platform 210 can be embodied as a consumer electronic device, such as a stand-alone Blu-ray Disc player or portable Blu-ray Disc player. Blu-ray platform 210 can also be embodied as a personal computer, a laptop, a notebook, or the like, having a Blu-ray Disc reader.

Blu-ray platform 210 can be configured to receive from sources 220 content that conforms to the Blu-ray Specification. For example, Blu-ray platform 210 may include an Blu-ray Disc reader that reads Blu-ray Disc 220A embedded with Blu-ray Specification conforming content 230. In another example, Blu-ray platform 210 may include storage device 220B having Blu-ray Specification conforming content 230 stored thereon. In yet another example, Blu-ray platform 210 may include an interface to one or more communications networks 220C through with Blu-ray Specification conforming content 230 is accessible (e.g., via downloading to the storage device or via network streaming).

Blu-ray Specification conforming content 230 can include one or more various forms of content, such as video content 240, audio content 250, and interactive features 260. As discussed above, video, audio and subtitle streams can be multiplexed and stored in the M2TS container format. Video content 240 may include digital video. The digital video may be encoded using MPEG-2 compression, MPEG-1 compression, H.264/MPEG-4 AVC, and SMPTE VC-1. The digital video may also include subtitle or subpicture tracks. Video content 240 may include one or more digital video streams, angles, chapters, or the like. Audio content 250 may include digital audio. The digital audio may be encoded using Pulse-code Modulation (PCM), Digital Theater System's Coherent Acoustics codec (DTS), MPEG-1 Audio Layer II (MP2), Dolby Digital (AC-3) format, or the like. Audio content 250 may optionally support Dolby Digital Plus and DTS-HD High Resolution Audio as well as lossless formats Dolby TrueHD and DTS-HD Master Audio. Audio content 250 may include one or more digital audio streams, languages, effects, channels, tracks, or the like.

Interactive features 260 may include a wide variety of extra features in addition to video content 240 and audio content 250. Interactive features 260 may also be recorded, stored, and/or streamed separately from video content 240 and audio content 250. Interactive content 260 can include content such as audio commentary that is timed to a film sequence, documentary features, deleted scenes, photo galleries, storyboards, isolated music scores, trivia text commentary, games, film shorts, TV spots, radio spots and most commonly theatrical trailers, teaser trailers, or the like. Other extras or features may include menus, motion features, still pictures, selectable subtitles, seamless branching for multiple storylines, camera angles, and data files.

Blu-ray Specification conforming content 230 may also include software. Blu-ray platform 210 may include Sun Microsystems' JAVA cross-platform software environment for executing the software. JAVA may be used to implement interactive menus, games, extra features, or the like. Blu-ray platform 210 may include a JAVA Virtual Machine. The virtual machine may provide network connectivity, allowing updates via the Internet, adding of content such as additional subtitle languages and promotional features not included on a disc at pressing time, or the like. A version of JAVA called BD-J may be included that provides a subset of the Globally Executable Multimedia Home Platform (GEM) standard. BD-J, or Blu-ray Disc Java, provides a specification supporting Java ME Xlets for advanced content on Blu-ray Disc and the Packaged Media profile of GEM. An Xlet is very similar to a Java applet and is designed to support applications for Digital TV as part of Sun's JAVA TV specification. Xlets can be paused and resumed.

In various embodiments, BD-J Xlets provided one or more of the following capabilities. The invocation of BD-J Xlets may be triggered by events occurring around them—for example, by the selection of a movie title, or by the insertion of a new disc. Xlets in turn can then call other Xlets into play. Security in BDJ may be based on the Java platform security model. Signed applications in JARs can perform more tasks than a non-signed, such as Read/Write access to local storage, network access, selection of other titles on the BD-ROM disc, and control of other running BD-J applications. BD-J has classes that allow synchronization to specific frames in the movie. A BD-J application's GUI can be operated with a remote control with a required set of keys and an optional pointing device. The set of required keys includes at least the keys needed to support the User Operations in HDMV applications. The GUI framework in BD-J includes the HAVi(6) UI framework mandated by GEM. The GUI framework is based on the core of AWT as specified by PBP, but the widget set includes mechanisms for remote control navigation from GEM and easy customization of look and feel from HAVi.

BD-J can include a media framework similar to JMF for the playback of media content related to the BD-ROM disc. The BD-ROM disc may be the prime source for media files, but other sources could be a studio's web server and local storage. BD-J can include standard Java libraries for decoding and displaying images in JFIF (JPEG), PNG and other image formats. These images can be displayed on the Java graphics plane using standard Java graphics functions. An image can also be rendered in the background plane using a BD-J specific package. Text can be rendered using standard Java text functions. These text-rendering functions can be extended with a more advanced text layout manager that integrates with the BD-J UI framework. The text may be rendered using a vector-based font either coming from the disc, the player (default font) or downloaded from the network.

Authenticated applications can use a (signed) permission request file to acquire permissions that go beyond a BD-J sandbox. Permissions can be acquired for: reading and writing to local and system storage; using the network connection (to connect to defined servers); access of the file system on the BD-ROM disc; title selection of other titles on the BD-ROM disc; control of other running BD-J applications; or the like. BD-J applications can use the java.net package to connect to servers on the Internet. Moreover, a Java package for secure connections may be included (JSSE) as part of the BD-J platform. BD-J can also include support for storage.

In addition to using M2TS files, Clip Information files, and playlists recorded on a Blue-ray Disc, Blu-ray platform 210 can support receiving of network streaming of Blu-ray Specification conforming content 230. Support may be provided, for example, through a virtual file system (VFS) where it is possible to mount a “Progressive PlayList.” A Progressive PlayList mechanism is set in a BD (see Part 3-2 of the BD read-only format: Interactive Application Standard, Attachment AA, the standardizing portion of system description which is hereby incorporated by reference for all purposes). A Progressive PlayList can be used to play a PlayList-like stream and download stream files from communications networks, such as the Internet. A Progressive PlayList generally consists of a plurality of small PlayItems, and need not correspond to all Clip AV streams of the clips before playing is started.

A play control engine can access one of the plurality of small PlayItems belonging to the Progressive PlayList and at the same time download another clip. The VFS can allow Blu-ray platform 210 to access content streams in a uniform way, such as Blu-ray platform 210 accesses Blu-ray Discs. Thus, playback of streams of content that conforms to the Blu-ray Specification may start without Blu-ray platform 210 having received all the data (allowing thus video streaming). However, one or more conditions need to be met in that any playlists and Clip Information files must be downloaded first to Blu-ray platform 210 before starting the playback. Additionally, the downloaded playlists and Clip Information files cannot be updated over time in a seamless fashion.

Accordingly, Blu-ray platform 210 may be limited in that it cannot receive live streaming or other dynamic streaming programs. Content stream distributer cannot readily predict what Clip Information files will be used in the future and which would need to be sent to Blu-ray platform 210. Additionally, Blu-ray platform 210 may not be able to implement dynamic/on the fly video transcoding. Some of these problems with Blu-ray streaming come from the typical data flow when compressing A/V information. Specifically, A/V information may be separately compressed using variable bit-rate (VBR), constant bit-rate (CBR), average CBR, etc. techniques, and then multiplexed. These encoding parameters are typically dictated by standards and any A/V content. As a result, there usually is a 1:1 match between a transport stream and its Clip Information file.

In various embodiments, constraints may be placed on sources of Blu-ray Specification conforming content 230. Once transport streams are appropriately constrained, a pre-defined playlist and group of Clip Information files can be used to stream content over time. Accordingly, Blu-ray platform 210 can use a single Clip Information file or a group of Clip Information files implementing true video streaming instead of having unique a Clip Information file for each transport stream.

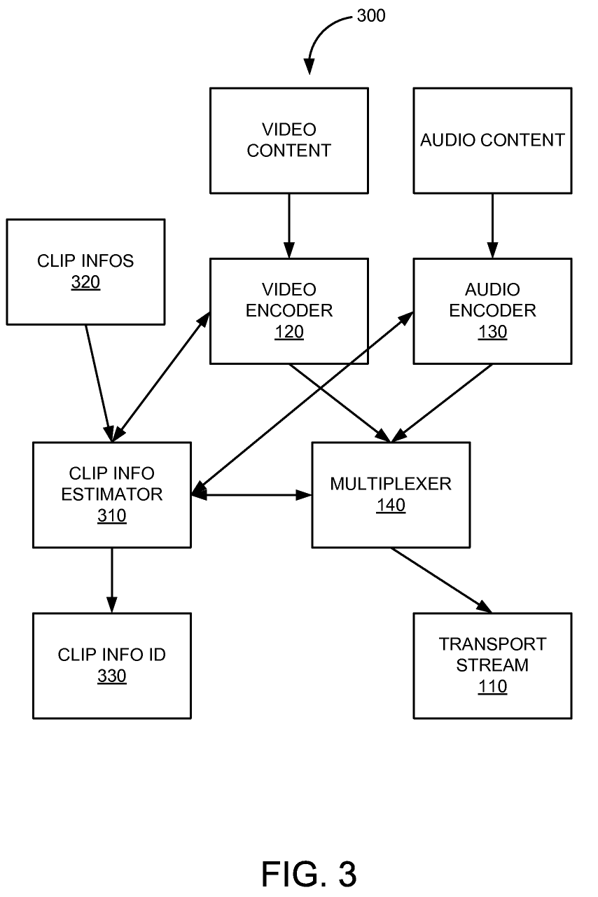

FIG. 3 is a block diagram of system 300 for generating streams of Blu-ray Specification conforming content in one embodiment according to the present invention. FIG. 3 may merely be illustrative of an embodiment or implementation of an invention disclosed herein should not limit the scope of any invention as recited in the claims. One of ordinary skill in the art may recognize through this disclosure and the teachings presented herein other variations, modifications, and/or alternatives to those embodiments or implementations illustrated in the figures.

In this example, system 300 includes Clip Information file estimator 310. Clip Information file estimator 310 can include hardware and/or software elements configured for placing constraints on a source of Blu-ray Specification conforming content that enables use by platform conforming to the Blu-ray Specification of a single Clip Information file or a group of Clip Information files implementing true video streaming. For example, Clip Information file estimator 310 receives one or more Clip Information files 320. Clip Information file estimator 310 exchanges information with video encoder 120, audio encoder 130, and multiplexer 140. Clip Information file estimator 310 determines which Clip Information file to use for the type of content, bitrate, and quality the of Blu-ray Specification conforming content. Clip Information file estimator 310 then exchanges information with video encoder 120, audio encoder 130, and multiplexer 140 to produce a transport stream.

Video encoder 120, audio encoder 130, and multiplexer 140 then produce a transport stream that conforms to the selected Clip Information file. The conforming transport stream can be sent to platforms conforming to the Blu-ray specification along with Clip Information file ID 330 which represents the Clip Information file used to generate the conforming transport stream. Once this data is constructed, a predefined playlist may be constructed based on the one or more Clip Information files 320 to implement network streaming of the conforming transport stream.

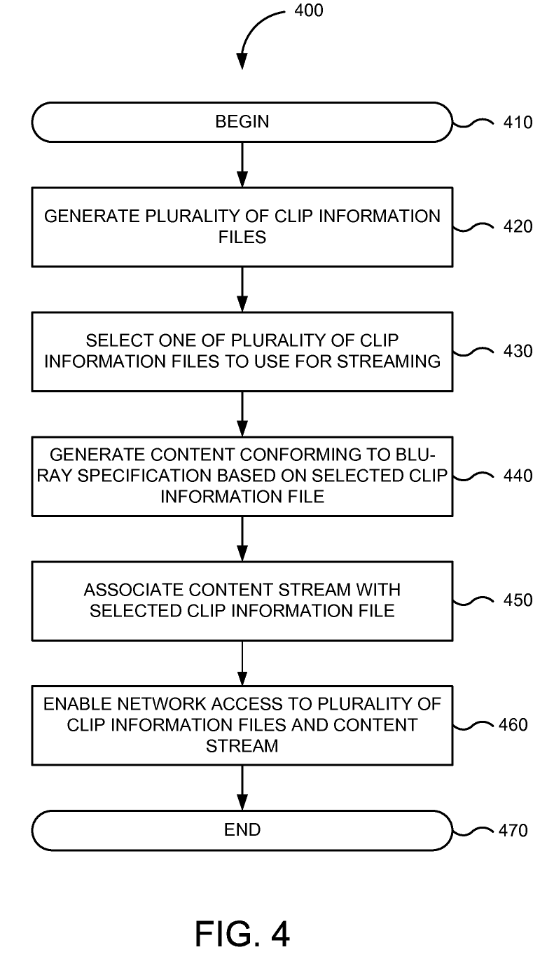

FIG. 4 is a flowchart of method 400 for generating streams of Blu-ray Specification conforming content in one embodiment according to the present invention. The processing of method 400 depicted in FIG. 4 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 400 depicted in FIG. 4 begins in step 410.

In step 420, a plurality of Clip Information files is generated. In various embodiments, a Clip Information file may be generated for each one of different types of content, bitrates, and quality. In step 430, one of the plurality of Clip Information files is selected. For example, a content distributor may select an appropriate Clip Information file that specifies information for a selected type of content, bitrate, and/or quality of content to be streamed.

In step 430, content conforming to Blu-ray Specification is generated based on the selected Clip Information file. In various embodiments, different Clip Information files may be selected for different portions of the content. In step 440, the generated content stream is associated with the selected Clip Information file. Metadata associated with the generated content stream may include information associated with the Clip Information file, such as a Clip Information Identifier (ID).

In step 460, network access is enabled to the plurality of Clip Information files and the generated content. As discussed above, the generated content can be sent to platforms conforming to the Blu-ray specification along with the plurality of Clip Information files. Once this data is constructed by a platform, a predefined playlist may be constructed based on the plurality of Clip Information files to implement network streaming of the conforming transport stream. FIG. 4 ends in step 470.

In various embodiments, Blu-ray platform 210 may include BD-J flow control software. The BD-J flow control software may manage the plurality of Clip Information files and loop over them to implement video streaming. In one embodiment, a simple implementation may be having an one-size-fits-all Clip Information file. However, just like CBR compression, it may lead to less than optimum efficiency.

In further embodiments, each of the plurality of Clip Information files can correspond to different data layouts. By having a wider choice, compression of the content may be more efficient. Additionally, the plurality of Clip Information files can represent various ‘angles’. The BD-J flow control software can then pick the correct Clip Information file from the plurality of Clip Information files (e.g., the correct flavor). Using a seamless Blu-ray angle change, the best compression may then be presented to the user.

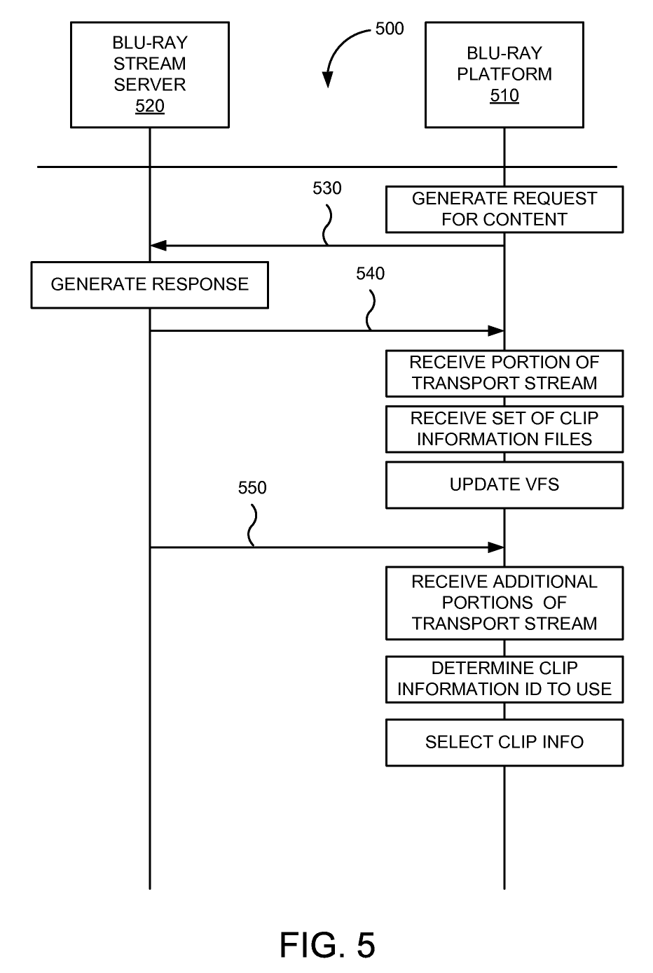

FIG. 5 is a message sequence chart 500 illustrating the streaming of content conforming to the Blu-ray Specification in one embodiment according to the present invention. In this example, Blu-ray platform 510 (e.g., client software hosted by Blu-ray platform 510) may generate a request for content from Blu-ray Stream Server 520. Request 530 may for forwarded from Blu-ray platform 510 to Blu-ray Stream Server 520 via one or more communications networks, such as the Internet. Blu-ray Stream Server 520 may generate a response to request 530. Response 540 may be forwarded from Blu-ray Stream Server 520 to Blu-ray platform 510. Response 540 may include a portion of a requested transport stream, one or more playlists, and/or one or more Clip Information files. Response 540 may include information enabling downloading of the portion of the requested transport stream, the one or more playlists, and/or the one or more Clip Information files. The one or more Clip Information files may be embodied as the plurality of Clip Information files discussed above in regard to FIGS. 3 and 4.

Next, Blu-ray platform 510 receives a portion of requested transport stream. Blu-ray platform 510 receives the one or more playlists and/or the one or more Clip Information files. Blu-ray platform 510 may store the data in persistent storage. The portion of the requested transport stream may be downloaded to meet buffering requirements. Blu-ray platform 510 then updates the VFS to make any downloaded playlists effective.

Blu-ray Stream Server 520 then may forward or otherwise communicate additional portions of the requested transport stream or additional transport streams. Stream data 550 send from Blu-ray Stream Server 520 may include information specifying which one of the one or more Clip Information files to use with each additional portions of the requested transport stream or each additional transport stream.

In various embodiments, Blu-ray platform 510 receives any additional portions of the requested transport stream or any additional transport streams. Blu-ray platform 510 receives the information specifying which one of the one or more Clip Information files to use with each additional portions of the requested transport stream or each additional transport stream. Blu-ray platform 510 determines which one of the one or more Clip Information files to use. Blu-ray platform 510 selects the identified one of the one or more Clip Information files to use. For example, Blu-ray platform 510 may include a client flow controller that instruct playback middleware to select the identified one of the one or more Clip Information files to use.

In further embodiments, one or more Clip Information files of various durations may be used. Sometimes, Clip Information files can have time-to-byte offsets fixed, as the layout is as per spec, but the Clip Information files do not point to any actual data. One drawback may be that using trick-play feature is not possible, (e.g. jumping forward in the movie is not possible). Operating in the context of streaming may further limit this feature.

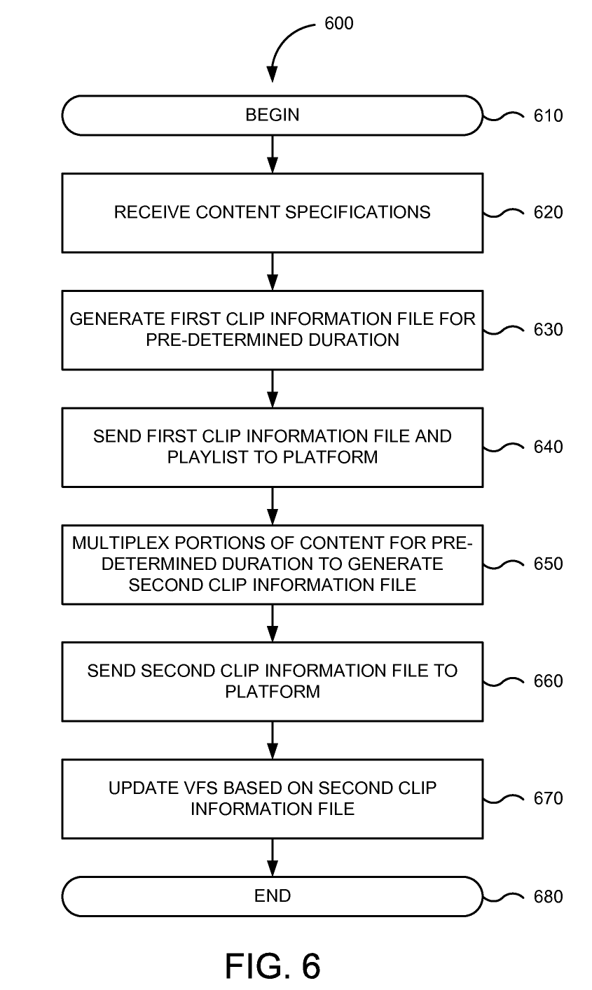

FIG. 6 is a flowchart of method 600 for generating streams of Blu-ray Specification conforming content in one embodiment according to the present invention. The processing of method 600 depicted in FIG. 6 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 600 depicted in FIG. 6 begins in step 610.

In step 620, content specifications are received. For example, the frame rate of any video information in the content is received or otherwise determined. In another example, the sampling frequency of any audio information in the content is received or otherwise determined. Other specification or format metadata of the content may be received or otherwise determined.

In step 630, a first Clip Information file is generated for a pre-determined duration. In one embodiment, a common metric is determined to have integer numbers of video frames/audio frames (e.g., 24 fps and 48 kHz (AC3 has 2536 samples per frame) 4 seconds). The comment metric then can be used to represent the clip duration (e.g., 4 seconds) for which the first Clip Information file is generated. Time-to-space offsets can be distributed linearly in such a way the any resulting Clip Information files are legal from a standards point of view.

In step 640, the first Clip Information file and a relative playlist is send to a platform that conforms to the Blu-ray Specification. As discussed above, the platform can perform an update of the VFS to make the playlist effective.

In step 650, portions of the content are multiplexed for the pre-determined duration to generate a second clip information file. For example, multiplexer 140 may generate A/V data multiplexed for the pre-determined duration. A video stream may be properly crafted, in particular, to contain a video end sequence (using MPEG-2 video format, same concept can apply to VC1 and H264). The real corresponding Clip Information file is generated by the multiplexer 140 as the second clip information file.

In step 660, the second Clip Information file is sent to the platform. The muxed content may also be send to the platform.

In step 670, the VFS is updated based on the second clip information file. The second Clip Information file representing the real output of the multiplexer process can be used by the platform when and if features, such as trick play, are required. At that point, a new VFS update is performed to make the actual clip-info files part of the VFS. FIG. 6 ends in step 680.

In various embodiments, data rates can be managed dynamically in a seamless fashion for an end user. Typically, even with broadband internet connections, bitrates required for HD streaming may still be greedy.

In some embodiments, Blu-ray platform 510 can include BD-J flow control software that monitors the network data rate capability in real time. Blu-ray platform 510 then may adjust to the best quality for a given bitrate. In order to offer a seamless experience to a user when Blu-ray platform 510 adjusts the bitrate, the above-discussed various angles in the Clip Information files may be used while streaming the correct transport stream file or switching at clip boundaries (e.g., driven by Blu-ray Stream Server 520).

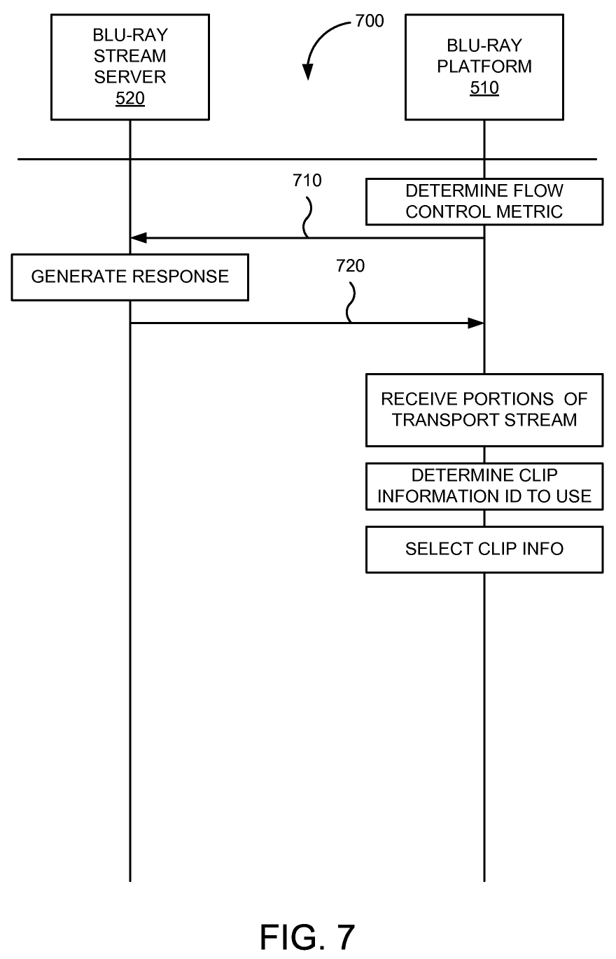

FIG. 7 illustrates a message sequence chart 700 illustrating the streaming of content conforming to the Blu-ray Specification in one embodiment according to the present invention.

In this example, Blu-ray platform 510 (e.g., client software hosted by Blu-ray platform 510) may determine one or more flow control metrics. The one or more metrics may include network data rate capabilities, such as connection speed, average speed, bandwidth, quality of service, jitter, delay, or the like. Metric 710 may for forwarded from Blu-ray platform 510 to Blu-ray Stream Server 520 via one or more communications networks, such as the Internet.

Blu-ray Stream Server 520 may generate a response to metric 710. Response 720 may be forwarded from Blu-ray Stream Server 520 to Blu-ray platform 510. Response 540 may include a portion of a requested transport stream, one or more playlists, and/or one or more Clip Information files. Response 540 may include information enabling downloading of the portion of the requested transport stream, the one or more playlists, and/or the one or more Clip Information files. The one or more Clip Information files may be embodied as the plurality of Clip Information files discussed above in regard to FIGS. 3 and 4.

Blu-ray Stream Server 520 then may forward or otherwise communicate portions of the requested transport stream or additional transport streams. Stream data may be send from Blu-ray Stream Server 520 and may include information specifying which one of the one or more Clip Information files to use with each additional portions of the requested transport stream or each additional transport stream. Blu-ray platform 510 also receives the information specifying which one of the one or more Clip Information files to use with each additional portions of the requested transport stream or each additional transport stream. Blu-ray platform 510 determines which one of the one or more Clip Information files to use. Blu-ray platform 510 selects the identified one of the one or more Clip Information files to use. For example, Blu-ray platform 510 may include a client flow controller that instruct playback middleware to select the identified one of the one or more Clip Information files to use.

In various embodiments, Blu-ray platform 510 may implement a big enough buffer that allows the possibility to time-shift and trick play the content. Accordingly, Blu-ray platform 510 may performing transcoding in real time, receive Live TV or live broadcast, and implement Bandwidth optimized flow control as discussed above.

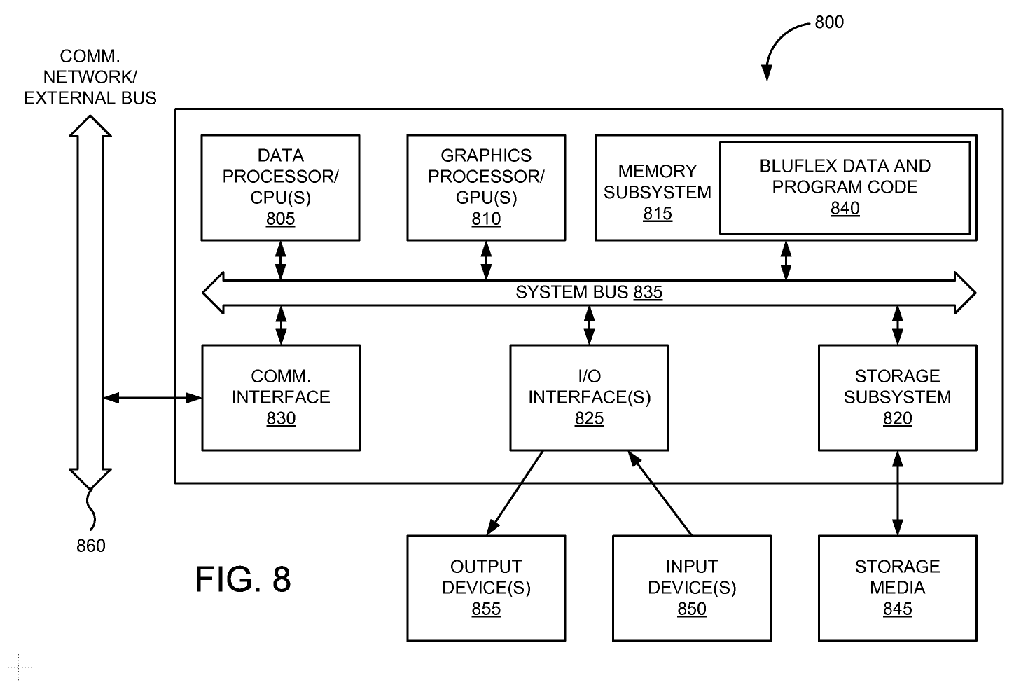

FIG. 8 is a block diagram of computer system 800 that may incorporate an embodiment, be incorporated into an embodiment, or be used to practice any of the innovations, embodiments, and/or examples found within this disclosure. FIG. 8 is merely illustrative of a computing device, general-purpose computer system programmed according to one or more disclosed techniques, or specific information processing device for an embodiment incorporating an invention whose teachings may be presented herein and does not limit the scope of the invention as recited in the claims. One of ordinary skill in the art would recognize other variations, modifications, and alternatives.

Computer system 800 can include hardware and/or software elements configured for performing logic operations and calculations, input/output operations, machine communications, or the like. Computer system 800 may include familiar computer components, such as one or more one or more data processors or central processing units (CPUs) 805, one or more graphics processors or graphical processing units (GPUs) 810, memory subsystem 815, storage subsystem 820, one or more input/output (I/O) interfaces 825, communications interface 830, or the like. Computer system 800 can include system bus 835 interconnecting the above components and providing functionality, such connectivity and inter-device communication. Computer system 800 may be embodied as a computing device, such as a personal computer (PC), a workstation, a mini-computer, a mainframe, a cluster or farm of computing devices, a laptop, a notebook, a netbook, a PDA, a smartphone, a consumer electronic device, a gaming console, or the like.

The one or more data processors or central processing units (CPUs) 805 can include hardware and/or software elements configured for executing logic or program code or for providing application-specific functionality. Some examples of CPU(s) 805 can include one or more microprocessors (e.g., single core and multi-core) or micro-controllers, such as PENTIUM, ITANIUM, or CORE 2 processors from Intel of Santa Clara, Calif. and ATHLON, ATHLON XP, and OPTERON processors from Advanced Micro Devices of Sunnyvale, Calif. CPU(s) 805 may also include one or more field-gate programmable arrays (FPGAs), application-specific integrated circuits (ASICs), or other microcontrollers. The one or more data processors or central processing units (CPUs) 805 may include any number of registers, logic units, arithmetic units, caches, memory interfaces, or the like. The one or more data processors or central processing units (CPUs) 805 may further be integrated, irremovably or moveably, into one or more motherboards or daughter boards.

The one or more graphics processor or graphical processing units (GPUs) 810 can include hardware and/or software elements configured for executing logic or program code associated with graphics or for providing graphics-specific functionality. GPUs 810 may include any conventional graphics processing unit, such as those provided by conventional video cards. Some examples of GPUs are commercially available from NVIDIA, ATI, and other vendors. In various embodiments, GPUs 810 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 810 may include any number of registers, logic units, arithmetic units, caches, memory interfaces, or the like. The one or more data processors or central processing units (CPUs) 805 may further be integrated, irremovably or moveably, into one or more motherboards or daughter boards that include dedicated video memories, frame buffers, or the like.

Memory subsystem 815 can include hardware and/or software elements configured for storing information. Memory subsystem 815 may store information using machine-readable articles, information storage devices, or computer-readable storage media. Some examples of these articles used by memory subsystem 870 can include random access memories (RAM), read-only-memories (ROMS), volatile memories, non-volatile memories, and other semiconductor memories. In various embodiments, memory subsystem 815 can include Bluflex data and program code 840.

Storage subsystem 820 can include hardware and/or software elements configured for storing information. Storage subsystem 820 may store information using machine-readable articles, information storage devices, or computer-readable storage media. Storage subsystem 820 may store information using storage media 845. Some examples of storage media 845 used by storage subsystem 820 can include floppy disks, hard disks, optical storage media such as CD-ROMS, DVDs and bar codes, removable storage devices, networked storage devices, or the like. In some embodiments, all or part of Bluflex data and program code 840 may be stored using storage subsystem 820.

In various embodiments, computer system 800 may include one or more hypervisors or operating systems, such as WINDOWS, WINDOWS NT, WINDOWS XP, VISTA, or the like from Microsoft or Redmond, Wash., SOLARIS from Sun Microsystems, LINUX, UNIX, and UNIX-based operating system. Computer system 800 may also include one or more applications configured to executed, perform, or otherwise implement techniques disclosed herein. These applications may be embodied as Bluflex data and program code 840. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 815 and/or storage subsystem 820.

The one or more input/output (I/O) interfaces 825 can include hardware and/or software elements configured for performing I/O operations. One or more input devices 850 and/or one or more output devices 855 may be communicatively coupled to the one or more I/O interfaces 825.

The one or more input devices 850 can include hardware and/or software elements configured for receiving information from one or more sources for computer system 800. Some examples of the one or more input devices 850 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 850 may allow a user of computer system 800 to interact with one or more non-graphical or graphical user interfaces to enter a comment, select objects, icons, text, user interface widgets, or other user interface elements that appear on a monitor/display device via a command, a click of a button, or the like.

The one or more output devices 855 can include hardware and/or software elements configured for outputting information to one or more destinations for computer system 800. Some examples of the one or more output devices 855 can include a printer, a fax, a feedback device for a mouse or joystick, external storage systems, a monitor or other display device, a communications interface appropriately configured as a transceiver, or the like. The one or more output devices 855 may allow a user of computer system 800 to view objects, icons, text, user interface widgets, or other user interface elements.

A display device or monitor may be used with computer system 800 and can include hardware and/or software elements configured for displaying information. Some examples include familiar display devices, such as a television monitor, a cathode ray tube (CRT), a liquid crystal display (LCD), or the like.

Communications interface 830 can include hardware and/or software elements configured for performing communications operations, including sending and receiving data. Some examples of communications interface 830 may include a network communications interface, an external bus interface, an Ethernet card, a modem (telephone, satellite, cable, ISDN), (asynchronous) digital subscriber line (DSL) unit, FireWire interface, USB interface, or the like. For example, communications interface 830 may be coupled to communications network/external bus 880, such as a computer network, to a FireWire bus, a USB hub, or the like. In other embodiments, communications interface 830 may be physically integrated as hardware on a motherboard or daughter board of computer system 800, may be implemented as a software program, or the like, or may be implemented as a combination thereof.

In various embodiments, computer system 800 may include software that enables communications over a network, such as a local area network or the Internet, using one or more communications protocols, such as the HTTP, TCP/IP, RTP/RTSP protocols, or the like. In some embodiments, other communications software and/or transfer protocols may also be used, for example IPX, UDP or the like, for communicating with hosts over the network or with a device directly connected to computer system 800.

As suggested, FIG. 8 is merely representative of a general-purpose computer system appropriately configured or specific data processing device capable of implementing or incorporating various embodiments of an invention presented within this disclosure. Many other hardware and/or software configurations may be apparent to the skilled artisan which are suitable for use in implementing an invention presented within this disclosure or with various embodiments of an invention presented within this disclosure. For example, a computer system or data processing device may include desktop, portable, rack-mounted, or tablet configurations. Additionally, a computer system or information processing device may include a series of networked computers or clusters/grids of parallel processing devices. In still other embodiments, a computer system or information processing device may techniques described above as implemented upon a chip or an auxiliary processing board.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A method for generating content streams that conform to the Blu-ray Specification, the method comprising:
receiving, at one or more content stream creation devices, information representing a Clip Information file;
generating, with the one or more content stream creation devices, a transport stream that conforms to the Blu-ray Specification for content received at the one or more content stream creation devices based on the Clip Information file; and
communicating, to a platform that conforms to the Blu-ray Specification, information that configures the platform to initiate, using the Clip Information file, playback of a portion of the transport stream generated by the one or more content stream creation devices.

2. The method of claim 1 wherein receiving the information representing the Clip Information file comprises receiving a fixed output file layout for the transport stream.

3. The method of claim 1 wherein receiving the information representing the Clip Information file comprises receiving a plurality of fixed output file layouts for the transport stream.

4. The method of claim 1 further comprising selecting, at the one or more content stream creation devices, the Clip Information file from a plurality of Clip Information files based on the content.

5. The method of claim 1 wherein generating the transport stream for the content based on the Clip Information file comprises:
receiving, at the one or more content stream creation devices, video information associated with the content;
encoding, at the one or more content stream creation devices, the video information based on the Clip Information file;
receiving, at the one or more content stream creation devices, audio information associated with the content;
encoding, at the one or more content stream creation devices, the audio information based on the Clip Information file; and
multiplexing, at the one or more content stream creation devices, portions of the encoded video information and portions of the encoded audio information based on the Clip Information file to create the transport stream for the content.

6. The method of claim 1 wherein communicating the information that configures the platform to initiate playback of a portion of the transport stream using the Clip Information file comprises communicating information that configures the platform to loop over a plurality of Clip Information files that includes the Clip Information file.

7. The method of claim 1 wherein communicating the information that configures the platform to initiate playback of a portion of the transport stream using the Clip Information file comprises communicating information that configures the platform use BD angles to select a desired video compression for the corresponding portion of the transport stream.

8. The method of claim 1 wherein communicating the information that configures the platform to initiate playback of a portion of the transport stream using the Clip Information is performed in response to information received from the platform indicative of network bandwidth usage.

9. The method of claim 8 wherein communicating the information that configures the platform to initiate playback of a portion of the transport stream using the Clip Information file comprises communicating information that configures the platform to switch to a first BD angle for the portion of the transport stream from a second BD angle for another portion of the transport stream.

10. The method of claim 1 further comprising storing the transport stream in a storage device.

11. An computer-readable storage medium storing computer-executable instructions for generating content streams that conform to the Blu-ray Specification, the computer-readable storage medium comprising:
instructions for receiving information representing a Clip Information file;
instructions for generating a transport stream that conforms to the Blu-ray Specification for content received at the one or more content stream creation devices based on the Clip Information file; and
instructions for communicating, to a platform that conforms to the Blu-ray Specification, information that configures the platform to initiate, using the Clip Information file, playback of a portion of the transport stream generated by the one or more content stream creation devices.

12. The computer-readable storage medium of claim 11 wherein the instructions for receiving the information representing the Clip Information file comprise instructions for receiving a fixed output file layout for the transport stream.

13. The computer-readable storage medium of claim 11 wherein the instructions for receiving the information representing the Clip Information file comprise instructions for receiving a plurality of fixed output file layouts for the transport stream.

14. The computer-readable storage medium of claim 11 further comprising instructions for selecting the Clip Information file from a plurality of Clip Information files based on the content.

15. The computer-readable storage medium of claim 11 wherein the instructions for generating the transport stream for the content based on the Clip Information file comprise:
instructions for receiving video information associated with the content;
instructions for encoding the video information based on the Clip Information file;
instructions for receiving audio information associated with the content;
instructions for encoding the audio information based on the Clip Information file; and
instructions for multiplexing portions of the encoded video information and portions of the encoded audio information based on the Clip Information file to create the transport stream for the content.

16. The computer-readable storage medium of claim 11 wherein the instructions for communicating the information that configures the platform to initiate playback of a portion of the transport stream using the Clip Information file comprise instructions for communicating information that configures the platform to loop over a plurality of Clip Information files that includes the Clip Information file.

17. The computer-readable storage medium of claim 11 wherein the instructions for communicating the information that configures the platform to initiate playback of a portion of the transport stream using the Clip Information file comprise instructions for communicating information that configures the platform use BD angles to select a desired video compression for the corresponding portion of the transport stream.

18. The computer-readable storage medium of claim 11 wherein the instructions for communicating the information that configures the platform to initiate playback of a portion of the transport stream using the Clip Information comprise instructions for performing the communication in response to information received from the platform indicative of network bandwidth usage.

19. The computer-readable storage medium of claim 18 wherein the instructions for communicating the information that configures the platform to initiate playback of a portion of the transport stream using the Clip Information file comprise instructions for communicating information that configures the platform to switch to a first BD angle for the portion of the transport stream from a second BD angle for another portion of the transport stream.

20. The computer-readable storage medium of claim 11 further comprising instructions for storing the transport stream in a storage device.

21. A method for generating content streams that conform to the Blu-ray Specification, the method comprising:
receiving, at one or more content stream creation devices, one or more metrics associated with the content;
generating, at the one or more content stream creation devices, information representing a Clip Information file having a predetermined duration based on the one or more metrics associated with the content;
constraining, with the one or more content stream creation devices, generation by the one or more content stream creation devices of a transport stream that conforms to the Blu-ray Specification for the content based on the Clip Information file; and
storing a portion of the transport stream in a storage device associated with the one or more content stream creation devices.

22. The method of claim 21 wherein receiving the one or more metrics associated with the content comprises:
receiving, at the one or more content stream creation devices, a frame rate associated with video information in the content; and
receiving, at the one or more content stream creation devices, a sampling rate associated with audio information in the content.

23. The method of claim 21 wherein generating the information representing the Clip Information file having a predetermined duration based on the one or more metrics associated with the content comprises:
determining a common metric between a plurality of types in the content; and
determining a duration using the common metric.

24. The method of claim 21 further comprising:
communicating, to a platform that conforms to the Blu-ray Specification, information that configures the platform to initiate, using the Clip Information file, playback of the portion of the transport stream generated by the one or more content stream creation devices.

25. A computer-readable storage medium storing computer-executable instructions for implementing the method of claim 21.
